(19) United States
(12) Patent Application Publication
(10) Pub. No.: US 2017/0324311 A1
(43) Pub. Date: Nov. 9, 2017

(54) SWITCHED RELUCTANCE MOTOR

(71) Applicant: HONDA MOTOR CO., LTD., Tokyo (JP)

(72) Inventor: Takahiro TSUTSUI, Saitama (JP)

(73) Assignee: HONDA MOTOR CO., LTD., Tokyo (JP)

(21) Appl. No.: 15/589,122

(22) Filed: May 8, 2017

(30) Foreign Application Priority Data
May 9, 2016 (JP) 2016-093968

(51) Int. Cl. H02K 19/10; H02K 1/14; H02K 1/24; H02K 3/18

(52) U.S. Cl. CPC H02K 19/103; H02K 3/18; H02K 1/146; H02K 1/24

(57) ABSTRACT

A switched reluctance motor includes a stator having an annular stator core which has teeth portions provided with poles, which are arranged in a circumferential direction of the stator core, wherein the stator core has a circular cross-sectional contour orthogonal to an axis thereof, a winding wound around the teeth portion, and a rotor having a rotor core which has salient pole portions provided with poles, which are arranged at regular intervals in a circumferential direction of the rotor core. The number of the poles with the salient pole portions is 5 poles×N, and the number of the poles with the teeth portion is 6 poles×N (The above two “N” are an equal natural number.). The salient pole portion has inclined surfaces in which both end corners in the circumferential direction are chamfered.

### CROSS-REFERENCE TO RELATED APPLICATION

This application claims priority from Japanese Patent Application No. 2016-093968 filed on May 9, 2016, the entire contents of which are incorporated herein by reference.

### TECHNICAL FIELD

The present invention relates to a switched reluctance motor.

### BACKGROUND ART

Switched reluctance motors having a simple structure with no permanent magnet have been known. In the switched reluctance motor, a plurality of teeth of a stator are arranged at regular intervals in a circumferential direction of the stator and extends in a radial direction of the stator. For this reason, the area of salient poles facing the teeth is small, a magnetic path between the stator and a rotor is distorted and lengthened, and the loss of a motor is large.

As a solution to these problems, patent literature 1 discloses a switched reluctance motor in which the number of poles provided with teeth portions 13 of the stator is 6 poles×N, the number of poles provided with salient pole portions of the rotor is 5 poles×N (The above two “N” are an equal natural number.), a stator core is provided with first slots and second slots that are alternately formed in the circumferential direction and differ in the shape of a cross section orthogonal to an axis of the stator core, and the radial thickness of a first back yoke forming the first slots is larger than the radial thickness of a second back yoke forming the second slots. In addition, since a pair of the teeth portions forming the first slot are arranged on extended lines of two adjacent salient poles in the circumferential direction, distortion of a magnetic path is suppressed and thus the magnetic path can be shortened. Therefore, the loss of a motor can be reduced.

### PRIOR ART LITERATURE

### Patent Literature

Patent Literature 1: JP-A-2015-201922

### SUMMARY OF THE INVENTION

### Problem that the Invention is to Solve

However, the switched reluctance motor in which the stator has 6×N poles and the rotor has 5×N poles as described above has a problem of large torque ripple. FIG. 6 is a graph showing changes in torque in accordance with rotation angles of the rotor of the switched reluctance motor disclosed in patent literature 1. As shown in FIG. 6, when three-phase current is supplied to the switched reluctance motor disclosed in patent literature 1, since a torque overlap of phases is large, the peak of the output torque of the switched reluctance motor is high and thus torque ripple is large.

An object of the invention is to provide a switched reluctance motor capable of reducing torque ripple.

### Means for Solving the Problem

With a view to achieving the object, according to an invention of claim 1, there is provided a switched reluctance motor (for example, SR motor 1 in the embodiment), including:

a stator (for example, stator 3 in the embodiment) including an annular stator core (for example, stator core 11 in the embodiment) which has teeth portions (for example, teeth portion 13 in the embodiment) provided with poles, which are arranged in a circumferential direction of the stator core, wherein the stator core has a circular cross-sectional contour orthogonal to an axis thereof;

a winding (for example, winding 4 in the embodiment) wound around the teeth portion; and

a rotor (for example, rotor 2 in the embodiment) including a rotor core (for example, rotor core 6 in the embodiment) which has salient pole portions (for example, salient pole portion 8 in the embodiment) provided with poles, which are arranged at regular intervals in a circumferential direction of the rotor core,

wherein the number of the poles with the salient pole portions is 5 poles×N (N is a natural number), and the number of the poles with the teeth portions is 6 poles×N (The above two “N” are an equal natural number.), and

the salient pole portion has inclined surfaces in which both end corners in the circumferential direction are chamfered.

According to an invention of claim 2, in the invention of claim 1, a length of an apical surface, facing the stator, of the salient pole portion in the circumferential direction is two thirds of a circumferential width of the salient pole portion due to the chamfered corners, and

an angle between a tangent line of an outer periphery of the rotor core and the inclined surface at an intersection of the outer periphery of the rotor core and the inclined surface is about 60°.

According to an invention of claim 3, in the invention according to claim 1, the stator core includes a first slot (for example, first slot 15 in the embodiment) and a second slot (for example, second slot 16 in the embodiment) which are alternately arranged in the circumferential direction, wherein the first slot and the second slot have different cross-sectional shapes orthogonal to the axis,

a radial thickness of a first back yoke (for example, first back yoke 12a in the embodiment) forming the first slot is larger than a radial thickness of a second back yoke (for example, second back yoke 12b in the embodiment) forming the second slot, and

a pair of the teeth portions forming the first slot are arranged on extended lines of adjacent two of the salient pole portions in the circumferential direction.

### Advantage of the Invention

According to claim 1, since the both end corners of the salient pole portions in the circumferential direction are chamfered, when three-phase current is supplied to the switched reluctance motor, a torque overlap between phases is reduced. When the torque overlap between phases is reduced, since the peak of the torque output by the switched reluctance motor is lowered, and thus the torque ripple can be reduced. In addition, since the both end corners of the salient pole portions in the circumferential direction are chamfered, a salient pole ratio (Ld/Lq) that is a ratio of d-axis inductance to q-axis inductance is increased. Since the torque of each phase is high at a high salient pole ratio, the reduction in the average torque output by the switched reluctance motor can be suppressed.

Since the salient pole portion is formed to have the inclined surfaces according to claim 2, it is possible to minimize the ripple rate of the torque output by the switched reluctance motor while suppressing the reduction in the average torque.

According to claim 3, since a pair of the teeth portions forming the first slot therebetween are arranged on extended lines of two adjacent salient pole portions in the circumferential direction, the distortion of the magnetic path is suppressed and thus the magnetic path can be shortened. Therefore, the loss of the motor can be reduced and the weight increase of the motor attributable to the increased size of the rotor can be suppressed.

Also, as to the annular stator, since the radial thickness of the first back yoke forming the first slot having a shape different from that of the second slot is larger than the radial thickness of the second back yoke forming the second slot, the cross-sectional area, orthogonal to the axis, of the first slot and the cross-sectional area, orthogonal to the axis, of the second slot can be equalized. Therefore, the space factor of the winding in the first slot and the space factor of the winding in the second slot can be equalized. Further, since the radial thickness of the first back yoke can be increased, it is possible to improve torque density and power density while suppressing an increase in the outer diameter of the stator.

### BRIEF DESCRIPTION OF DRAWINGS

FIG. 1 is a vertical cross-sectional view illustrating a switched reluctance motor according to one embodiment of the present invention.

FIG. 2 is an enlarged view illustrating a first slot and a periphery portion of a second slot of FIG. 1.

FIG. 3 is an enlarged view illustrating a portion of a rotor core of the switched reluctance motor according to the present embodiment of the present invention.

FIG. 4 is a graph illustrating changes in torque in accordance with rotation angles of a rotor of the switched reluctance motor according to the present embodiment of the present invention.

FIG. 5 is a graph illustrating changes in ripple rate and mean value of torque output by the switched reluctance motor in accordance with angles α of an inclined surface shown in FIG. 3.

FIG. 6 is a graph illustrating changes in torque in accordance with rotation angles of a rotor of a switched reluctance motor disclosed in patent literature 1.

### MODE FOR CARRYING OUT THE INVENTION

Hereinafter, an embodiment of the invention will be described with reference to the accompanying drawings. Herein, a switched reluctance motor used as a driving source of a vehicle such as an automobile will be described as an example in the description of the invention.

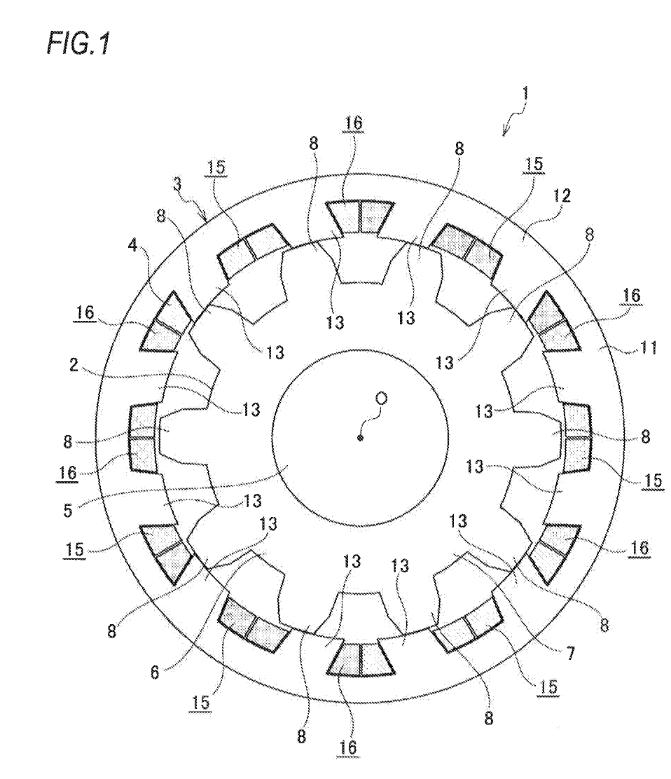

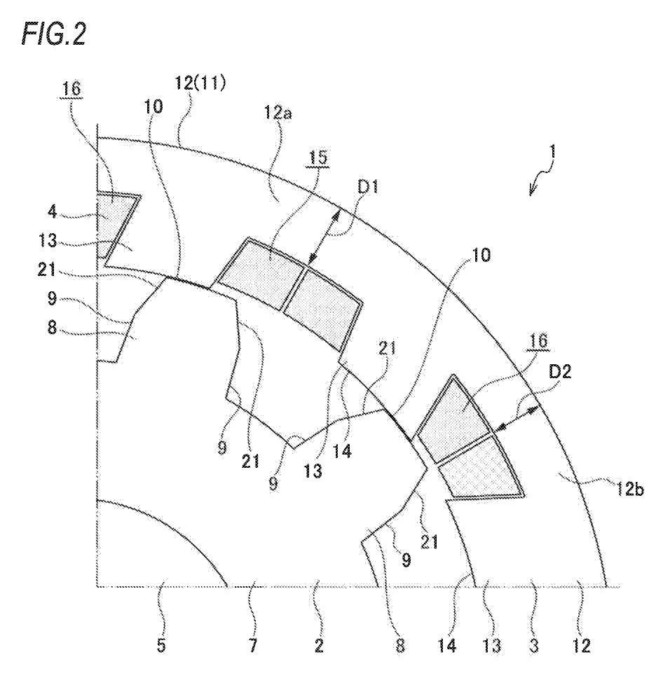

FIG. 1 is a vertical cross-sectional view illustrating a switched reluctance motor according to one embodiment of the invention. FIG. 2 is an enlarged view illustrating a first slot and a periphery portion of a second slot of FIG. 1.

As illustrated in FIG. 1, a switched reluctance motor 1 (hereinafter, simply referred to as an SR motor) includes a rotor 2, a stator 3, and a winding 4.

The rotor 2 includes a shaft 5 and a rotor core 6. The shaft 5 is supported to be rotatable with respect to the stator 3. The rotor core 6 protrudes radially outward from the outer circumferential surface of the shaft 5. The rotor core 6 is fixed in a fitted manner such that the axis O of the rotor core 6 and the shaft 5 overlap with each other. The rotor core 6 is formed in a cylinder shape by laminating a plurality of electromagnetic steel plates or the like in an axis direction.

The rotor core 6 includes a core body portion 7 and a plurality of salient pole portions 8.

The core body portion 7 is formed in an annular shape such that the core body portion 7 protrudes radially outward from the shaft 5.

In the present embodiment, as to one core body portion 7, 10 poles are provided with the salient pole portions 8. The salient pole portions 8 radially extend outward from the core body portion 7. The salient pole portions 8 are arranged at equal intervals in the circumferential direction. Each salient pole portion 8 has two side surfaces 9 extending in the radial direction, one apical surface 10 facing the inner circumferential surface of the annular stator 3, and two inclined surfaces 21 formed by chamfering both end corners of the salient pole in the circumferential direction.

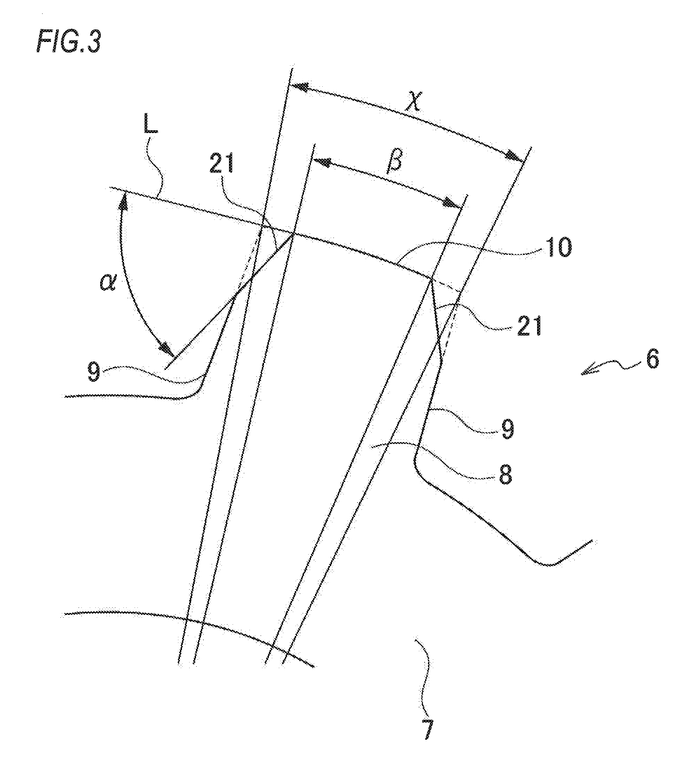

The apical surface 10 is a curved surface that extends in the circumferential direction and protrudes outward in the radial direction. As shown in FIG. 3, the length β of the apical surface 10 in the circumferential direction is shortened to two thirds of the circumferential width of the salient pole portion because the both end corners of the salient pole portion in the circumferential direction are chamfered. That is, the relation between the length χ, in the circumferential direction, of the apical surface of a typical salient pole portion that is not provided with the inclined surfaces 21 and the length β is “β=2χ/3”. The angle α between a tangent line L of the outer periphery of the rotor core 6 and the inclined surface 21 at an intersection of the outer periphery of the rotor core 6 and the inclined surface 21 is approximately 60°.

The stator 3 includes a stator core 11 having a circular cross-sectional contour orthogonal to the axis O. The star core 11 has an annular shape having an inner circular space in the radial direction such that the rotor 2 is accommodated in the inner circular space. The stator core 11 includes a yoke portion 12 and a plurality of teeth portions 13.

As shown in FIGS. 1 and 2, the yoke portion 12 has an annular shape, i.e. specifically a circular cylinder shape extending along the axis O.

The teeth portions 13 protrude inward from the yoke portion 12 in the radial direction. The teeth portions 13 have respective confrontation surfaces 14 respectively facing the apical surfaces 10 of the salient pole portions 8. The confrontation surfaces 14 are curved surfaces extending in the circumferential direction and recessed outward in the radial direction.

The stator core 11 is provided with first slots 15 and second slots 16 that are spaces through which the winding 4 passes. The first slots 15 communicate with an inside space in the radial direction of the stator core 11, the inside space being open toward the rotor 2. Similarly, the second slots 16 communicate with the inside space in the radial direction of the stator core 11, the inside space being open toward the rotor 2. The first slot 15 and the second slot 16 are alternately arranged in the circumferential direction of the stator core 11. A side surface of the first slot 15 and a side surface of the second slot 16 are inclined flat surfaces all of which are inclined at an equal angle. The first slot 15 and the second slot 16 have different cross-sectional shapes orthogonal to the axis O.

Here, the teeth portions 13 adjacent to each other in the circumferential direction are inclined in opposite directions in terms of the circumferential direction. In addition, the width dimension of the first slot 15 in the circumferential direction gradually increases inward in the radial direction, but the width dimension of the second slot 16 in the circumferential direction gradually decreases toward inward in the radial direction. Therefore, a pair of the teeth portions 13 forming one first slot 15 therebetween can be arranged on extended lines of the salient pole portions 8, wherein the number of the salient pole portions 8 is smaller than the number of the teeth portions 13 (See FIG. 3.).

The radial thickness D1 of a first back yoke 12a forming the first slots 15 is greater than the radial thickness D2 of a second back yoke 12b forming the second slots 16. Due to a difference between the radial thickness D1 and the radial thickness D2, the cross-sectional area, orthogonal to the axis O, of the first slot 15 is equal to the cross-sectional area, orthogonal to the axis O, of the second slot 16.

The winding 4 is wound around the first slots 15 and the second slots 16 adjacent to each other in the circumferential direction. In other words, the winding 4 passes through the first slots 15 and the second slots 16, and forms a winding group in which the winding is wound around the teeth portion 13 by several turns. Two winding groups adjacent to each other in the circumferential direction pass through one first slot 15. The shapes of the cross sections, orthogonal to the axis O, of the two winding groups passing through one first slot 15 are symmetric with each other. Similarly, two winding groups adjacent to each other in the circumferential direction pass through one second slot 16. The shapes of cross sections, orthogonal to the axis O, of the two winding groups passing through one second slot 16 are symmetric with each other.

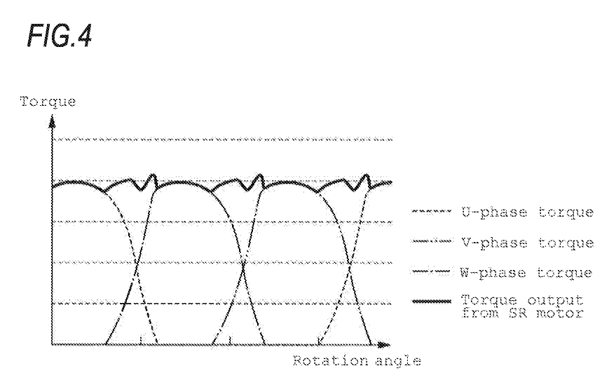

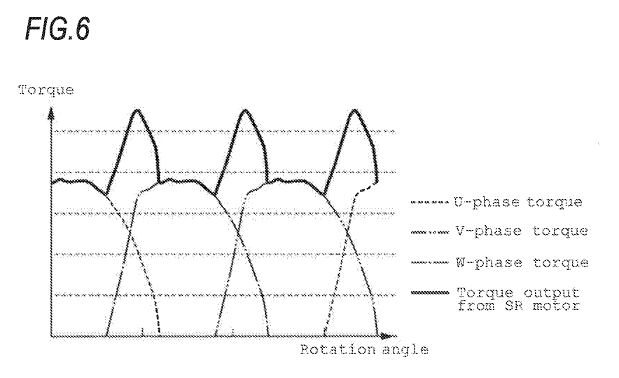

FIG. 4 is a graph illustrating changes in torque in accordance with rotation angles of the rotor 2 of the SR motor 1 according to the present embodiment. According to the present embodiment, the SR motor 1 has a structure in which both end corners of the salient pole portions 8 of the rotor core 6 in the circumferential direction are chamfered. Therefore, when three-phase current is supplied to the SR motor 1, a torque of each phase has a gentler rising slope and a steeper falling slope as shown in FIG. 4, compared with that of a conventional switched reluctance motor shown in FIG. 6. As a result, since a torque overlap between phases is reduced, the peak of the torque output by the SR motor 1 is lowered, and the torque ripple is reduced. In addition, due to the structure in which the corners of the salient pole portions 8 are chamfered, a salient pole ratio (Ld/Lq) that is a ratio of d-axis inductance to q-axis inductance is increased. When the salient pole ratio is increased, the torque of each phase is increased and thus reduction of the average torque output by the SR motor 1 can be suppressed.

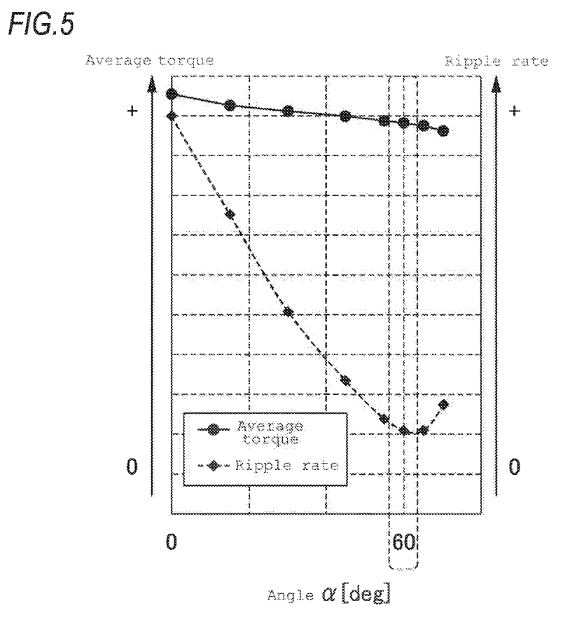

FIG. 5 is a graph showing changes in ripple rate and mean value of torque (hereinafter, referred to as “average torque”) output by the SR motor 1 in accordance with angles α of the inclined surface 21 shown in FIG. 3. In the present embodiment, the angle α of the inclined surfaces 21, formed by chamfering the corners of the salient pole portions 8, with respect to the tangent line L of the outer periphery of the rotor core 6 is about 60°. As shown in FIG. 5, when the angle α is about 60°, the ripple rate is lowest. Therefore, at an angle of 60°, the influence of the angle α on the average torque is not significant. Therefore, in the present embodiment, the corners of the salient pole 8 are chamfered such that the angle α is about 60°.

As described above, according to the present embodiment, since the both end corners of the salient pole portions 8 in the circumferential direction are chamfered, when three-phase current is supplied to the SR motor 1, a torque overlap between phases is small. When the torque overlap is small, the peak of the torque output by the SR motor 1 is lowered and the torque ripple can be reduced. In addition, since the both end corners of the salient pole portions 8 in the circumferential direction are chamfered, the salient pole ratio (Ld/Lq) is high. When the salient pole ratio is high, the torque of each phase increases and thus the reduction in the average torque of the SR motor 1 can be suppressed.

In addition, since a pair of the teeth portions 13 forming the first slot 15 are arranged on extended lines of two adjacent salient pole portions 8 in the circumferential direction, distortion of the magnetic path can be suppressed and thus the magnetic path can be shortened. Consequently, it is possible to reduce the loss of the SR motor 1, thereby suppressing the weight increase of the SR motor 1 attributable to the increased size of the rotor.

In addition, in the annular stator 3, since the radial thickness D1 of the first back yoke 12a forming the first slots 15 having a different shape from the second slots 16 is thicker than the radial thickness D2 of the second back yoke 12b forming the second slots 16, the cross-sectional area, orthogonal to the axis O, of the first slot 15 and the cross-sectional area, orthogonal to the axis O, of the second slot 16 can be equalized with each other. Therefore, it is possible to equalize the space factor of the winding 4 in the first slots 15 with the space factor of the winding 4 in the second slots 16. Further, since the radial thickness D1 of the first back yoke 12a can be increased, it is possible to improve the torque density and power density while suppressing the increase in the outer diameter of the stator.

In addition, it should be noted that the present invention is not limited to the configurations of the above-described embodiments and the design can be changed without departing from the gist of the embodiments.

In the embodiment described above, the case where the cross-sectional shapes, orthogonal to the axis O, of the two winding groups passing through the first slot 15 are symmetric with each other in the circumferential direction has been described. However, the present invention is not limited to this configuration. That is, the cross sections may be asymmetric.

Further, although the SR motor 1 serving as a driving source of a vehicle has been described as an example, the present invention is not limited to an SR motor for driving a vehicle.

Further, in the above-described embodiment, the case where the number of poles provided with the salient pole portions 8 is 10, and the number of poles provided with the teeth portions 13 is 12. However, a combination of the number of poles provided with the salient pole portions 8 and the number of poles provided with the teeth portions 13 is not limited to the above combination of 10 poles and 12 poles. For example, it may be a combination of 20 poles provided with the salient pole portions 8 and 24 poles provided with the teeth portions 13. Alternatively, the present invention is applicable to a combination of 5 poles provided with the salient pole portions 8 and 6 poles provided with the teeth portions 13, a combination of 30 poles provided with the salient pole portions 8 and 36 poles provided with the teeth portions 13, or a combination of 40 poles provided with the salient pole portions 8 and 48 poles provided with the teeth portions 13. That is, it is sufficient that the combination of the number of poles provided with the salient pole portions 8 and the number of poles provided with the teeth portions 13 of the SR motor 1 satisfies the relationship in which the number of poles provided with the salient pole portions 8 is 5 poles×N, and the number of poles provided with the teeth portions 13 is 6 poles×N (The above two “N” are an equal natural number.).

### DESCRIPTION OF REFERENCE NUMERALS AND CHARACTERS

1 SR motor (Switched Reluctance motor)
2 rotor
3 stator
4 winding
6 rotor core
7 core body portion
8 salient pole portion
9 side surface
10 apical surface
21 inclined surface
11 stator core
12 yoke portion
13 teeth portion
12a first back yoke
12b second back yoke
15 first slot
16 second slot
O axis
L tangent line

1. A switched reluctance motor, comprising:
a stator including an annular stator core which has teeth portions provided with poles, which are arranged in a circumferential direction of the stator core, wherein the stator core has a circular cross-sectional contour orthogonal to an axis thereof;
a winding wound around the teeth portion; and
a rotor including a rotor core which has salient pole portions provided with poles, which are arranged at regular intervals in a circumferential direction of the rotor core,
wherein the number of the poles provided with the salient pole portions is 5 poles×N (N is a natural number), and the number of the poles provided with the teeth portions is 6 poles×N (The above two “N” are an equal natural number.), and
the salient pole portion has inclined surfaces in which both end corners in the circumferential direction are chamfered.

2. The switched reluctance motor according to claim 1,
wherein a length of an apical surface, facing the stator, of the salient pole portion in the circumferential direction is two thirds of a circumferential width of the salient pole portion due to the chamfered corners, and
an angle between a tangent line of an outer periphery of the rotor core and the inclined surface at an intersection of the outer periphery of the rotor core and the inclined surface is about 60°.

3. The switched reluctance motor according to claim 1,
wherein the stator core includes a first slot and a second slot which are alternately arranged in the circumferential direction, wherein the first slot and the second slot have different cross-sectional shapes orthogonal to the axis,
a radial thickness of a first back yoke forming the first slot is larger than a radial thickness of a second back yoke forming the second slot, and
a pair of the teeth portions forming the first slot are arranged on extended lines of adjacent two of the salient pole portions in the circumferential direction.
